(19) United States
(12) Patent Application Publication
(10) Pub. No.: US 2013/0302901 A1
(43) Pub. Date: Nov. 14, 2013

(54) Electrodes for Sensing Chemical Composition

(71) Applicants: Stuart Lindsay, Phoenix, AZ (US); Peiming Zhang, Gilbert, AZ (US); Brett Gyarfas, Chandler, AZ (US); Suman Sen, Tempe, AZ (US); Shuai Chang, Tempe, AZ (US); Steven Lefkowitz, Branford, CT (US); Hongbo Peng, Chappaqua, NY (US)

(72) Inventors: Stuart Lindsay, Phoenix, AZ (US); Peiming Zhang, Gilbert, AZ (US); Brett Gyarfas, Chandler, AZ (US); Suman Sen, Tempe, AZ (US); Shuai Chang, Tempe, AZ (US); Steven Lefkowitz, Branford, CT (US); Hongbo Peng, Chappaqua, NY (US)

(21) Appl. No.: 13/838,727

(22) Filed: Mar. 15, 2013

Related U.S. Application Data
(60) Provisional application No. 61/620,167, filed on Apr. 4, 2012.

(51) Int. Cl. G01N 27/327

(52) U.S. Cl. CPC G01N 27/3275
USPC 436/94; 422/82.01; 156/60

(57) ABSTRACT

Some embodiments of the present disclosure provide methods, devices, and systems for sequencing nucleic acid polymers that utilize palladium (Pd), for example, at least in part, as an electrode material that is (i) functionalized with one or more adaptor molecules and (ii) capable for use to sense one or more chemical compositions.

### RELATED APPLICATIONS

This application claims benefit under 35 USC §119(e) of U.S. provisional patent application no. 61/620,167, filed Apr. 4, 2012, entitled, “Electrodes for Sensing Chemical Composition” the entire disclosure of which is herein incorporated by reference.

### STATEMENT REGARDING FEDERALLY SPONSORED RESEARCH & DEVELOPMENT

Inventions of the present application were made with government support under NIH Grant No. R01 HG006323, awarded by the National Institute of Health. The U.S. Government has certain rights in inventions disclosed herein.

### TECHNICAL FIELD

The subject matter described herein relates to methods, devices, and systems for sequencing nucleic acid polymers.

### BACKGROUND

Nucleic acid bases can be read by using electron tunneling current signals generated as the nucleotides pass through a tunnel gap functionalized with adaptor molecules. For example, PCT publication nos. WO2009/117522A2, WO 2010/042514A1, WO 2009/117517, and WO2008/124706A2, U.S. publication nos. US2010/0084276A1, and US2012/0288948, are all hereby incorporated by reference herein in their entireties. Conventionally, bases have been read using gold electrodes functionalized with adaptor molecules. Carbon nanotubes functionalized with adaptor molecules have also been described for use as electrodes in PCT publication nos. WO2009/117517 and WO 2010/042514A1, and U.S. publication nos. US2011/0168562 and US2011/0120868, which are incorporated herein by reference in their entireties.

While gold has been found to work well as an electrode material, it suffers from limitations. For examples, it is often incompatible with current technologies used for fabricating electronic devices, owing to its rapid diffusion in silicon and its propensity to form deep level traps, reducing minority carrier lifetime. Second, the tunneling signals generated by the most successful adaptor molecule tried to date, i.e., (4(5)-(2-mercaptoethyl)-1H imidazole-2-carboxamide), can have a large background generated by water alone. This is illustrated in FIG. 1, which shows the distribution of signal heights for water alone and the four bases. Current peaks from bases are larger on average, but the distributions are all highly overlapped. There is considerable overlap between the water background and the signals generated by the bases. While the water signals have a time dependence that allows them to be removed from the signal train, this processing is complicated and reduces the accuracy of the reads. Devices that utilize carbon nanotubes functionalized with adaptor molecules to sense chemical compositions can also be difficult to fabricate.

In view of the foregoing, it would be desirable to provide improved methods, devices, and systems for sequencing nucleic acid polymers. In one aspect according to some embodiments, methods, devices, and systems for sequencing nucleic acid polymers are provided that utilize an electrode material, functionalized with one or more adaptor molecules, that is compatible with semiconductor fabrication processes. In another aspect according to some embodiments, methods, devices, and systems for sequencing nucleic acid polymers are provided that utilize an electrode material, functionalized with one or more adaptor molecules, that is capable of generating signals from DNA nucleobases without interference from water signals. One or both of these improvements and advantages, and/or other improvements and advantages, can be provided in accordance with the present disclosure.

### SUMMARY OF SOME OF THE EMBODIMENTS

Embodiments of the subject matter described herein provide methods, devices, and systems for sequencing nucleic acid polymers.

For example, some embodiments of the present disclosure provide methods, devices, and systems for sequencing nucleic acid polymers that utilize palladium (Pd), at least in part (e.g., whether it be pure palladium, a palladium alloy, or other composition comprising palladium), as an electrode material that is (i) functionalized with one or more adaptor molecules and (ii) capable for use to sense one or more chemical compositions.

In some embodiments, a device for identifying a chemical composition (e.g., single molecules) and a corresponding method of fabricating the device are provided. The device includes a first electrode and a second electrode separated from the first electrode by a dielectric material (e.g., dielectric material having about 1 to 5 nm thickness). The first electrode, second electrode, or both have at least one adaptor molecule chemically tethered thereto. In some embodiments, at least one of the first electrode and the second electrode comprises palladium metal (e.g., pure palladium or a palladium alloy). In some embodiments, the adaptor molecule comprises 4(5)-(2-mercaptoethyl)-1H imidazole-2-carboxamide. In some embodiments, the adaptor molecule comprises 4H-1,2,4-triazole-3-carboxamide. In other embodiments, the adaptor molecule comprises 2-(2-carbamoyl-1H-imidazol-4-yl)ethylcarbamodithioate.

In an embodiment, an apparatus and corresponding method for sensing a chemical composition are provided. For example, in some embodiments, a nucleic acid base is caused to pass through a tunnel gap having electrically-separated electrodes, where at least one of the electrically-separated electrodes comprises palladium metal functionalized with an adaptor molecule. A type of the nucleic acid base is identified based on a tunneling current generated as a result of the nucleic acid base passing through the tunnel gap. In some embodiments, the adaptor molecule comprises 4(5)-(2-mercaptoethyl)-1H imidazole-2-carboxamide. In some embodiments, the adaptor molecule comprises 4H-1,2,4-triazole-3-carboxamide. In other embodiments, the adaptor molecule comprises 2-(2-carbamoyl-1H-imidazol-4-yl)ethylcarbamodithioate.

In some embodiments, a device for identifying one or more molecules (e.g., single molecules) is provided and comprises a first electrode, a second electrode separated from the first electrode by a dielectric material of about 1 to about 5 nm thickness, at least one adaptor molecule chemically tethered to the first electrode, and at least one adaptor molecule chemically tethered to the second electrode. In some embodiments, at least one of the first electrode and the second electrode comprises palladium metal.

In some embodiments, both of the first electrode and the second electrode comprise palladium metal. In some embodiments, at least one of the first electrode and the second electrode comprise an alloy of palladium. In some embodiments, at least one adaptor molecule tethered to the first electrode, the at least one adaptor molecule tethered to the second electrode, or both comprise 4(5)-(2-mercaptoethyl)-1H imidazole-2-carboxamide.

In some embodiments, at least one adaptor molecule tethered to the first electrode, the at least one adaptor molecule tethered to the second electrode, or both comprise 4H-1,2,4-triazole-3-carboxamide.

In some embodiments, the at least one adaptor molecule tethered to the first electrode, the at least one adaptor molecule tethered to the second electrode, or both comprise 2-(2-carbamoyl-1H-imidazol-4-yl)ethylcarbamodithioate.

In some embodiments, the electrodes are held under potential control with respect to reference electrode. In some embodiments, the potential of the palladium surface is maintained at between about +0.5V and about −0.5V vs. Ag/AgCl.

In some embodiments, an apparatus for sensing a chemical composition is provided and may comprise means for causing a nucleic acid base to pass through a tunnel gap having electrically-separated electrodes, where at least one of the electrically-separated electrodes comprises palladium metal functionalized with an adaptor molecule. Such embodiments may also include means for identifying a type of the nucleic acid base based on a tunneling current generated as a result of the nucleic acid base passing through the tunnel gap. Such means may be a computer processor analyzing signal data to determine the identity of the nucleic acid. Such means may also include databases for storing signature signal data for a plurality of molecules to be identified.

In some embodiments, both of the electrically-separated electrodes comprise palladium metal.

In some embodiments, at least one of the electrically-separated electrodes comprises an alloy of palladium.

In some embodiments, the adaptor molecule comprises 4(5)-(2-mercaptoethyl)-1H imidazole-2-carboxamide. In some embodiments, the adaptor molecule comprises 4H-1,2,4-triazole-3-carboxamide, or 2-(2-carbamoyl-1H-imidazol-4-yl)ethylcarbamodithioate.

In some embodiments, a method of fabricating a device capable of sensing a chemical composition is provided and may comprise one or more of the following steps (and in some embodiments, a plurality, and in some embodiments, all steps): providing a first electrode, providing a second electrode separated from the first electrode by a dielectric material of about 1 to about 5 nm thickness, chemically tethering at least one adaptor molecule to the first electrode, and chemically tethering at least one adaptor molecule to the second electrode. In some embodiments, at least one of the first electrode and the second electrode comprises palladium metal.

In some embodiments, such methods may also include at least one of chemically tethering at least one adaptor molecule to the first electrode, chemically tethering at least one adaptor molecule to the second electrode, or both, comprises chemically tethering 4(5)-(2-mercaptoethyl)-1H imidazole-2-carboxamide to the first electrode, second electrode, or both.

In some embodiments, such methods may also include at least one of chemically tethering at least one adaptor molecule to the first electrode, chemically tethering at least one adaptor molecule to the second electrode, or both, comprises chemically tethering 4H-1,2,4-triazole-3-carboxamide to the first electrode, second electrode, or both.

In some embodiments, such methods may include at least one of chemically tethering at least one adaptor molecule to the first electrode, chemically tethering at least one adaptor molecule to the second electrode, or both, comprises chemically tethering 2-(2-carbamoyl-1H-imidazol-4-yl)ethylcarbamodithioate to the first electrode, second electrode, or both.

In some embodiments, a method for sensing a chemical composition is provided and may include one or more of the following steps (in some embodiments, a plurality of such steps, and in some embodiments, all of such steps): causing a nucleic acid base to pass through a tunnel gap having electrically-separated electrodes, where at least one of the electrically-separated electrodes comprises palladium, and identifying a type of the nucleic acid base based on the tunneling current generated as a result of the nucleic acid base passing through the tunnel gap. Such identifying may comprise using computers, processors, and the like, to perform steps of analyzing the signal data to eliminate noise and defects, and/or comparing the signal data to signature signal data for a nucleic acid so as to identify the nucleic acid.

Some embodiments include a computer system for sensing a chemical composition, where the system comprising at least one processor, and where the processor includes computer instructions operating thereon for performing any of the methods taught by the present disclosure.

In some embodiments, a computer program for sensing a chemical composition is provided and comprises computer instructions for performing any of the methods taught by the present disclosure.

In some embodiments, a computer readable medium containing a program is provided, where the program includes computer instructions for performing any of the methods taught by the present disclosure.

### BRIEF DESCRIPTION OF THE DRAWINGS

The accompanying drawings, which are incorporated in and constitute a part of this specification, show certain aspects of the subject matter disclosed herein and, together with the description, help to explain some of the principles associated with the disclosed embodiments. In the drawings:

FIGS. 1A-F show distributions of pulse heights in tunneling signals generated from: water (A) and the nucleotides dAMP (B), dCMP (C), dCGP (D), dTMP (E) and d^{5-methyl}CMP (F) using functionalized gold electrodes for sensing chemical compositions. In the figure shown, the set-point tunnel current is 6 pA at 0.5V bias. The large background signals may reflect the presence of contamination, as they are not always so significant. Nonetheless, this background is frequently a problem in conventional systems.

FIG. 2A shows a schematic diagram of a tunnel gap created using a scanning tunneling microscope according to some embodiments of the present disclosure;

FIG. 2B shows a device according to some embodiments of the present disclosure fabricated by, for example, drilling a nanopore through two planar electrodes separated by a dielectric layer or other fabrication method;

FIG. 2C shows an enlarged, cross-sectional view of the nanopore region in FIG. 2B showing how the adaptor molecules span the tunnel gap and are connected to the electrodes on each side of the dielectric layer, according to some embodiments of the disclosure.

FIG. 3 illustrates a tunnel junction according to some embodiments of the present disclosure and, together with the accompanying text in this disclosure, illustrative fabrication steps for making the tunnel junction according to some embodiments;

FIG. 4 is a scanning electron microscope (“SEM”) image of a tunnel junction made with palladium (Pd) electrodes separated by a sub 5 nm layer of silicon dioxide (SiO₂) according to some embodiments of the present disclosure;

FIG. 5 is a transmission electron microscope (“TEM”) image of a nanopore drilled through a palladium (Pd) electrode on top of a dielectric support layer according to some embodiments of the present disclosure. In this figure, the atomic lattice of Pd atoms is clearly visible.

FIG. 6 is a trace diagram of tunnel current versus time for background signal taken in 1 milli-Molar (mM) phosphate buffer using Pd electrodes functionalized with 4(5)-(2-mercaptoethyl)-1H imidazole-2-carboxamide, according to some embodiments of the present disclosure. As shown, there is essentially no background signal at a tunnel conductance of 4 pS (current of 2 pA at 0.5V bias). The current scale is 0 to 80 pA and the time scale is 0.5 s.

FIG. 7 shows diagrams for typical signal traces for the four nucleotides when such nucleotides were added to a tunnel junction according to some embodiments of the present disclosure. In generating these traces, 100 μM in 1 mM phosphate buffer was used and utilizing Pd electrodes functionalized with 4(5)-(2-mercaptoethyl)-1H imidazole-2-carboxamide at a tunnel conductance of 4 pS (current of 2 pA at 0.5V bias). The current scales are approximately 0 to 80 pA and the time scales 0.3 to 0.5 s.

FIG. 8 shows diagrams illustrating the distribution of peak heights for the four nucleotides obtained at 4 pS (A) and 8 pS (B) using Pd electrodes functionalized with 4(5)-(2-mercaptoethyl)-1H imidazole-2-carboxamide according to some embodiments of the present disclosure.

FIG. 9 illustrates the synthesis of the adaptor molecule 4H-1,2,4-triazole-3-carboxamide for use in functionalizing device electrode(s) in accordance with some embodiments of the present disclosure.

FIG. 10 illustrates the preparation of the adaptor molecule dithiocarbamate derivative of 4(5)-(2-aminoethyl)-1H-imidazole-2-carboxamide for use in functionalizing device electrode(s) in accordance with some embodiments of the present disclosure.

FIGS. 11A is a graph of the measured tunneling current of 2′-deoxycytidine 5′-monophosphate, according to embodiments of the disclosure;

FIG. 11B is a graph of the measured tunneling current of 2′-deoxyguanosine 5′-monophosphate, using triazole-3-carboxamide as an adaptor or reading molecule according to some embodiments of the present disclosure.

FIG. 12 is a graph of the measured tunneling current of 2′-deoxycytidine 5′-monophosphate using imidazole dithiocarbamate as a reading molecule according to some embodiments of the present disclosure.

FIG. 13 is a graph of the measured tunneling current of 2′-deoxyadenosine 5′-monophosphate using imidazole dithiocarbamate as a reading molecule according to some embodiments of the present disclosure.

FIG. 14 is a graph of the measured tunneling current of thymidine 5′-monophosphate using imidazole dithiocarbamate as a reading molecule according to some embodiments of the present disclosure.

FIGS. 15-16 are example computer systems/networks that may be used with devices taught by the present disclosure, and may also be used to perform methods according to any of the methods taught by the present disclosure.

### DETAILED DESCRIPTION

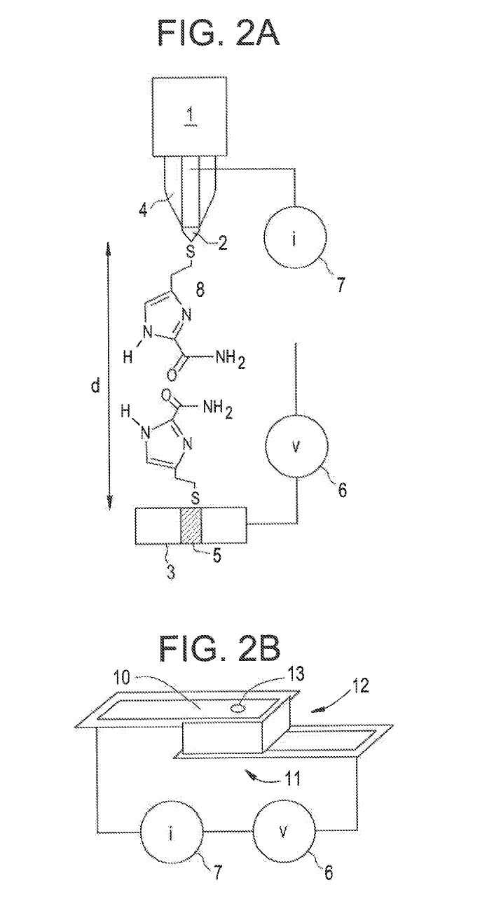

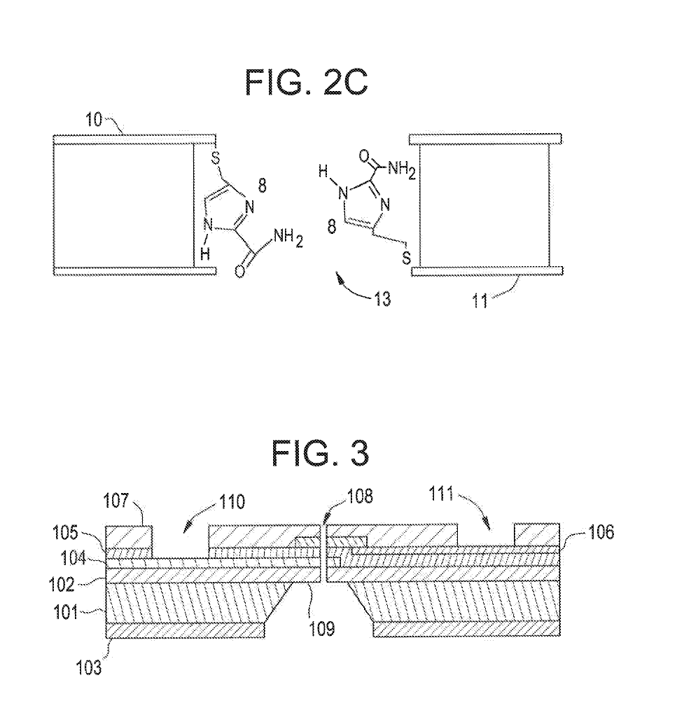

FIGS. 2A-C show illustrative embodiments an electrode system according to some embodiments of the present disclosure. FIG. 2A is representative of some embodiments based on a scanning tunneling microscope platform. A piezoelectric positioner (1) holds a metal probe (2) at a distance (d) from a metal substrate (3). In some embodiments, the metal is palladium, or an alloy of palladium, such as palladium-platinum or palladium-gold. In some embodiments, the distance, d, is set to between 2 and 3 nm by means of the positioner 1. In some embodiments, the entire arrangement of probe (2) and substrate (3) may be immersed in an aqueous electrolyte in which the DNA to be sequenced is dissolved in a single stranded form. In some embodiments, in order to minimize leakage currents the probe (2) is insulated to within a few microns of its apex with a dielectric material (4) such as polyethylene. Incorporated herein by reference in its entirety is Tuchband, M., He, J., Huang, S., and Lindsay, S., “Insulated gold scanning tunneling microscopy probes for recognition tunneling in an aqueous environment,” Rev, Sci. Instrum. 2012, 83, 015102.

Still referring to FIG. 2A, in some embodiments, the DNA is passed into the tunnel junction by electrophoretic transport through a nanopore drilled or otherwise formed through the substrate in close proximity to the tunnel junction (5). The aqueous electrolyte may be phosphate buffer with a concentration in the range of 1 to 100 mM, adjusted to pH 7.0, or other suitable aqueous electrolyte. A voltage bias V (6) may be applied across the tunnel junction, and the current, I, through the junction measured with a transconductance amplifier (7). Importantly, the electrodes are functionalized with one or more adaptor molecules (8). These are molecule(s) that form non-covalent bonds with DNA bases but are bonded (e.g., strongly bonded) to the metal electrodes, for example, via thiol linkages. In one embodiment, the adaptor molecule(s) tethered to the first and/or second electrodes is 4(5)-(2-mercaptoethyl)-1H-imidazole-2-carboxamide. Alternatively or in addition, other types of adaptor molecules may be tethered to the electrodes, for example, as described below in connection with FIGS. 9-14. DNA bases passing through the tunnel gap generate stochastic tunneling signals that can be used to identify the base in the tunnel gap.

FIGS. 2B and 2C show an electrode configuration for sensing according to some embodiments of the present disclosure. A first metal electrode (10) opposes a second metal electrode (11) spaced by a dielectric material (e.g., layer) (12). In some embodiments, the spacing is between 2 and 3 nm. Suitable dielectrics according to some embodiments include aluminum oxide, other metal oxides such a hafnium oxide, silicon dioxide, silicon nitride, or combinations thereof In some embodiments, one or both of electrodes 10 and 11 include palladium (e.g., pure palladium or a palladium alloy). In some embodiments, the electrodes include, or consist of, palladium (e.g., approximately 9 nm of Pd) on top of a titanium (Ti) adhesion layer (e.g., approximately 1 nm thick Ti adhesion layer). A nanopore (13) is drilled or otherwise formed through the two electrodes using, for example, an electron beam. FIG. 2C is an enlargement showing the electrodes (10, 11) and nanopore (13). In some embodiments, diameter of the nanopore is between approximately 1.5 and 5 nm. In some embodiments, the metal electrodes are functionalized with adaptor molecules (8), including, for example, one or more of the adaptor molecules described above and in connection with FIGS. 9-14.

FIG. 3 is a schematic diagram of a device according to some embodiments of the present disclosure. A silicon (Si) substrate (101) has insulating layers (102 and 103) such as silicon nitride (Si₃N₄) deposited on the front and back sides of the substrate (101). A window is opened on the backside through layer (103) via, for example, photolithography and reactive ion etching, and a through-substrate-via is etched from this window and ends on (102) to form a free-standing insulating membrane (109), for example, using wet etchant such as KOH or TMAH. An electrode (e.g., Pd or Pd alloy) layer (104) is deposited on top of insulating layer (102) and is then patterned, for example, via photolithography and metal lift-off processing. An insulating layer (105) is then deposited on top of the electrode layer (104). Another electrode (e.g., Pd or Pd alloy) layer (106) is deposited on top of (105) and patterned, for example, via photolithography and metal lift-off processing. The front side may be capsulated by an insulating layer (107). Via holes () and (111) are etched through insulating layers (107) and/or (105) to allow access to the metal electrode layers (104) and (106). In this way, two electrically addressable separated circular electrodes (e.g. Pd or Pd alloy electrodes) are made inside the nanopore for tunneling current measurements.

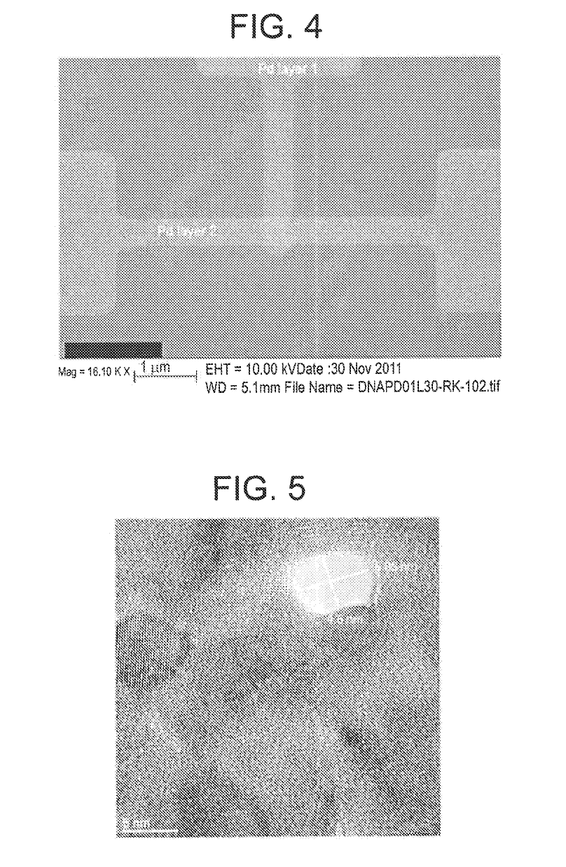

FIG. 4 is an SEM image of device fabricated as described above, but prior to forming (e.g., in this instance, drilling) of the nanopore. FIG. 5 is a high resolution TEM image of a nanopore drilled through a Pd electrode. The atomic structure of the Pd layer is clearly visible. These data demonstrate that fabrication of an electrode system compatible with silicon manufacturing processes has been achieved.

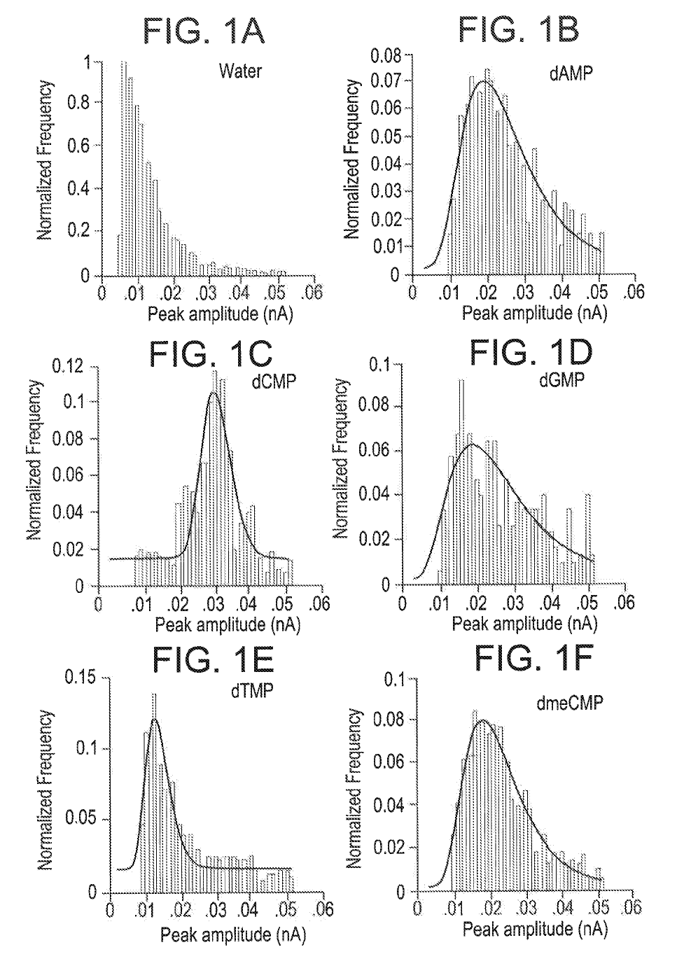

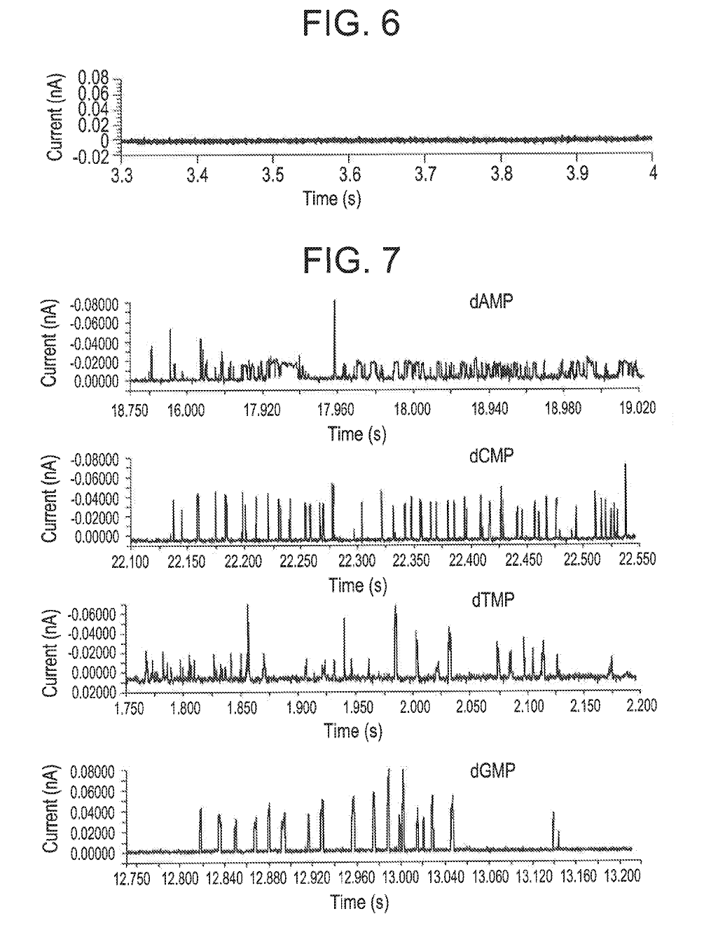

Another advantage of probes that include palladium (e.g., pure Pd or Pd alloy) lies with their ability to generate reads from DNA bases at a setpoint conductance that is much smaller than was used for gold electrodes with the 4(5)-(2-mercaptoethyl)-1H imidazole-2-carboxamide adaptor molecules. By way of illustration in accordance with some embodiments, and as shown below, reliable signals are obtained with a tunnel gap of 4 pS conductance, well below the 12 pS that had to be used to acquire the data taken with gold electrodes (FIG. 1). At 4 ps there were essentially no background signals at all when data was recorded in Phosphate Buffered Saline (PBS) buffer containing no nucleotides. An illustrative trace of tunnel current vs. time is shown in FIG. 6.

These same conditions also produced copious amounts of signal when nucleotides were added to the tunnel junction. FIG. 7 shows typical signal traces for some embodiments of the present disclosure for the four nucleotides at a background current of 2 pA with a bias of 0.5V (note that the scale on the plots shows the baseline tunnel current at or below 0 pA—this was a consequence of a small offset in the data acquisition system). As shown, the signals are large—in the range of 20 to 50 pS. In contrast, with conventional gold electrodes, no signals are generated at 4 pS conductance.

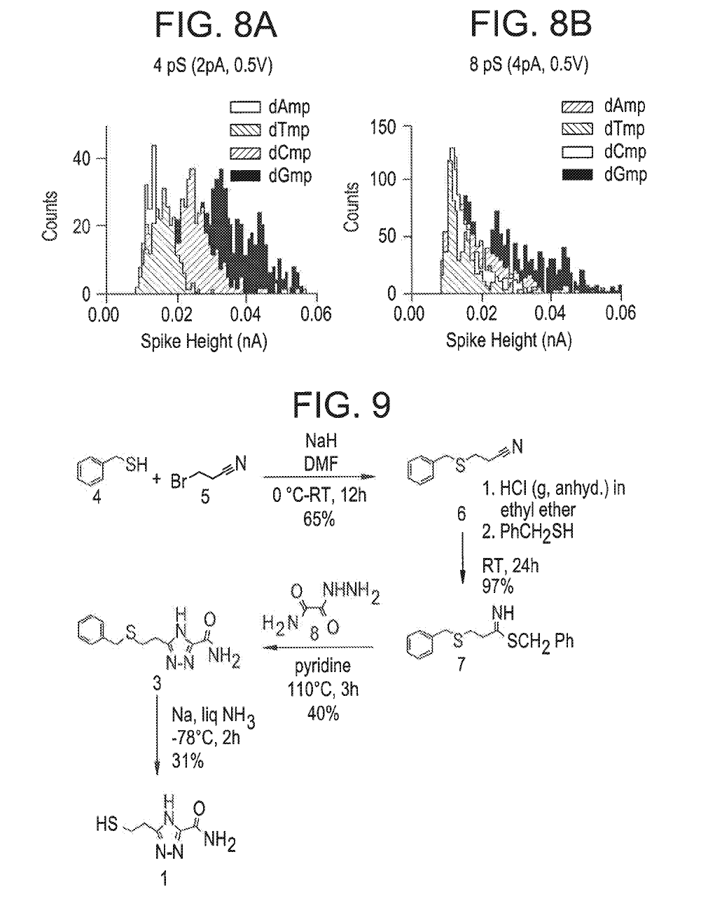

Operation at this low tunnel conductance provides excellent separation of the signals from the bases. FIG. 8 shows (A) the distribution of peak heights for all 4 nucleotides obtained at a tunnel conductance of 4 pS and (B) at 8 pS. As shown, the distributions are clearly better separated at 4 pS. The findings described herein that Pd produces such superior results when used for the functionalized electrode(s) within a device for sensing chemical compositions (e.g., instead to gold electrodes) was both surprising and unexpected. Lawson, J. W. and Bauschlicher, C. W., “Transport in Molecular Junctions with different molecular contacts,” Physical Review B 2006, 74, 125401, which is incorporated herein by reference in its entirety, includes a theoretical consideration of the tunneling currents that would be provided through a molecular junction by Ag, Au, Pd and Pt. Theoretical calculations were carried out for a phenoldithiol molecule directly bridging a pair of metal electrodes with one sulfur attached to one electrode and the other attached to the second electrode. These calculations showed that Pd electrodes might produce more current than Au electrodes in this case. However, there have been no calculations for the non-covalently-bonded complexes used in recognition tunneling so the effect of changing the metal electrode in that case is unknown.

The device configurations described above in connection with FIGS. 2-8 are only illustrative. Any other suitable configurations of a device for sensing chemical composition may be used, including with respect to device geometry (e.g., positioning, thickness, length, and width of the electrode(s) and/or dielectric(s)), materials selected for the metal(s) and/or dielectric(s), or both.

In various embodiments of the present disclosure, any suitable adaptor molecule(s) can be tethered to the first and/or second electrodes of a device as reading molecules for recognition tunneling. In some embodiments, the adaptor molecule is 4(5)-(2-mercaptoethyl)-1H imidazole-2-carboxamide. In some embodiments, the adaptor molecule is 4H-1,2,4-triazole-3-carboxamide. In some embodiments, the adaptor molecule is 2-(2-carbamoyl-1H-imidazol-4-yl)ethylcarbamodithioate.

Synthesis of the 5-substituted-4H-1,2,4-triazole-3-carboxamide molecule just described is described as follows and in connection with FIG. 9. With reference to FIG. 9, synthesis of (6) was accomplished as follows: sodium hydride (60% in mineral oil, 1.16 g, 24.0 mmol) was added to a solution of benzyl mercaptan (4) (1.05 g, 19.0 mmol) in anhydrous DMF (50 mL) at 0° C. under nitrogen atmosphere. The resulting mixture was stirred for 30 min at 0° C., followed by the dropwise addition of 3-bromopropanenitrile (5) (2.68 g, 20.0 mmol). The reaction mixture was stirred at 0° C. for 1 h and then allowed to warm to room temperature and stirred overnight to consume starting material completely. The reaction was stopped. The solvent was removed by rotary evaporation under reduced pressure followed by the addition of saturated aqueous NH₄Cl solution to quench and the solvent was removed by rotary evaporation under reduced pressure. The residuum was extracted with chloroform (3×20 mL). The combined organic layer was washed with water (3×10 mL), brine (30 mL) and concentrated under reduced pressure. The crude product was purified by silica gel flash column chromatography. Product (6) obtained (2.25 g, 65%) was pale yellow in color. The product was characterized and confirmed by NMR and mass spectrometry.

Still referring to FIG. 9, synthesis of (7) was accomplished as follows: compound (6) (2.0 g, 11.3 mmol) and benzyl mercaptan (4) (2.0 mL, 16.93 mmol) were sequentially added in anhydrous ethyl ether (120 mL) under nitrogen. The resulting solution was cooled to 0° C. and HCl (g, anhydrous) was bubbled for 2 hours (h) until it was saturated with hydrogen chloride. It was stirred for 24 h at room temperature. The product was spontaneously crystallized in the solution. It was collected on a filter paper by filtration through a Buchner funnel, washed with cold ethyl ether (50 mL), and dried in air then in vacuum. Product (7) was obtained in high yield (3.7 g, 97%). The product was characterized and confirmed by NMR and mass spectrometry.

With further reference to FIG. 9, synthesis of (3) was accomplished as follows: oxamic acid hydrazide (8) (0.34 g, 3.32 mmol) was added into a solution of compound (7) (1.0 g, 3.32 mmol) in anhydrous pyridine (10 mL) at room temperature under nitrogen. The resulting solution was refluxed at 110° C. for 3 h. Pyridine was co-evaporated with toluene (5 mL*2) under reduced pressure to obtain a yellow gummy liquid. DMSO (15 mL) was added to just dissolve the crude product and sufficient water (50 mL) was added to get white precipitate, which was filtered through a Buchner funnel and washed thoroughly with cold water (40 mL) followed by ethyl ether (40 mL). The solid was air-dried to obtain 0.53 g of the crude product, which was recrystallized from boiling ethanol (25 mL) to furnish 0.31 g (40%) of pure product (3) as white shiny crystals. The product was characterized and confirmed by NMR and mass spectrometry.

Still referring to FIG. 9, synthesis of (1) was accomplished as follows: compound (3) (150 mg, 0.572 mmol) was suspended in 2 mL of liquid NH₃. Freshly cut sodium was added till a permanent blue color was observed and stirred the reaction mixture for 1.5 h at −78° C. The reaction was quenched by addition of NH₄Cl and NH₃ was evaporated at room temperature. Column purification gave 98 mg of the product (1) (31%). The product was characterized by NMR and MALDI mass. Although the product is sensitive to air and readily oxidized to give disulfide or sulfone products, it was stored at 0° C. in its solid state with a good stability for few months.

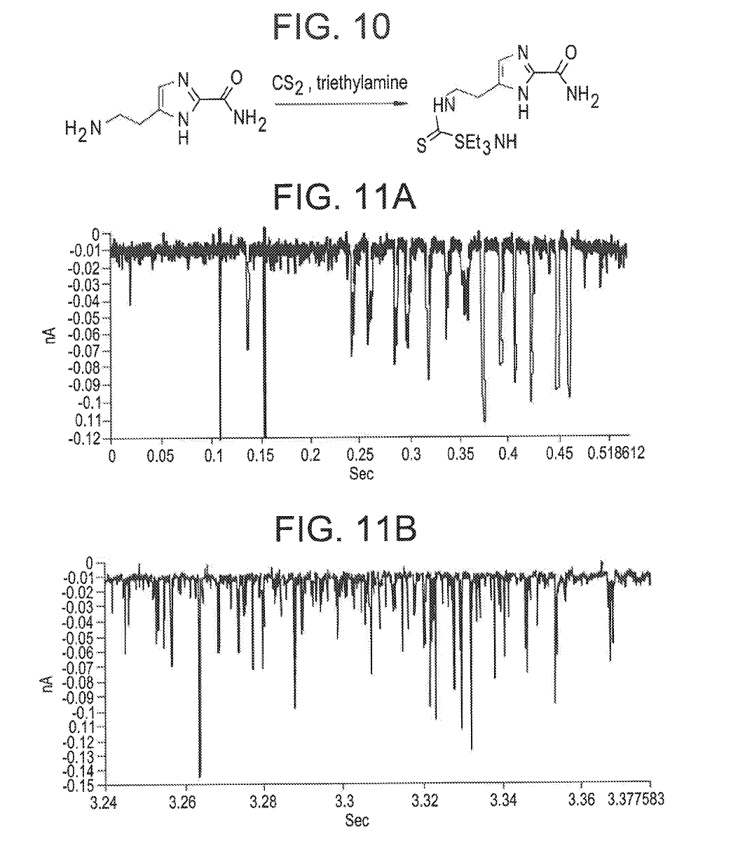

Preparation of the dithiocarbamate derivative of 4(5)-(2-aminoethyl)-1H-imidazole-2-carboxamide described above, for example, for use as a reading molecule for recognition tunneling is described as follows and in connection with FIG. 10. This is the same adaptor molecule 2-(2-carbamoyl-1H-imidazol-4-yl)ethylcarbamodithioate described above. With reference to FIG. 10, 4(5)-(2-aminoethyl)-1H-imidazole-2-carboxamide (77 mg, 0.32 mmol) and CS₂ (24 ul, 0.38 mmol) were dissolved in triethylamine (1.4 ml, 9.7 mmol). The mixture was stirred at room temperature for 24 h. The precipitate was filtered and washed with ethyl ether (5 ml×3) and dried in vacuum, giving the product with a near quantitative yield.

Tunneling measurements were taken using the adaptor molecules described in connection with FIGS. 9 and 10. In each instance, both palladium substrates and palladium tips were used for the measurements. Newly etched palladium tips were coated with high density polyethylene, rinsed with ethanol; the palladium substrates were annealed with hydrogen flame. Both palladium substrates and tips were immersed in a 1 mM solution of read molecule for about 24 hours, then rinsed copiously with ethanol and blow-dried with nitrogen. Tunneling measurements were performed in an Agilent PicoSPM instrument with self-made Labview software. This software collects trains of current vs. time data from a digital oscilloscope connected to the tunnel junction and presents it in graphical form where amplitude and other aspects of the spikes in tunnel current can be measured. PBS buffer (1 mM, 7.4 pH) was used for control tunneling measurements and 10 μM solution (in 1 mM, 7.4 pH PBS buffer) of nucleoside monophosphates were used for recognition measurements. Before recording the tunneling data, the system was left in an environmental chamber for more than 3 hours to be stabilized without any bias applied between the substrate and the tip. After the system was stabilized, different bias and setpoint was added between the substrate and the tip and the tunneling signal was collected.

FIG. 11 shows the tunneling measurements with the triazole-carboxamide adaptor molecule. The tunneling currents were measured at a set point of −0.5 v, 4 pA using a Pd probe and Pd substrate.

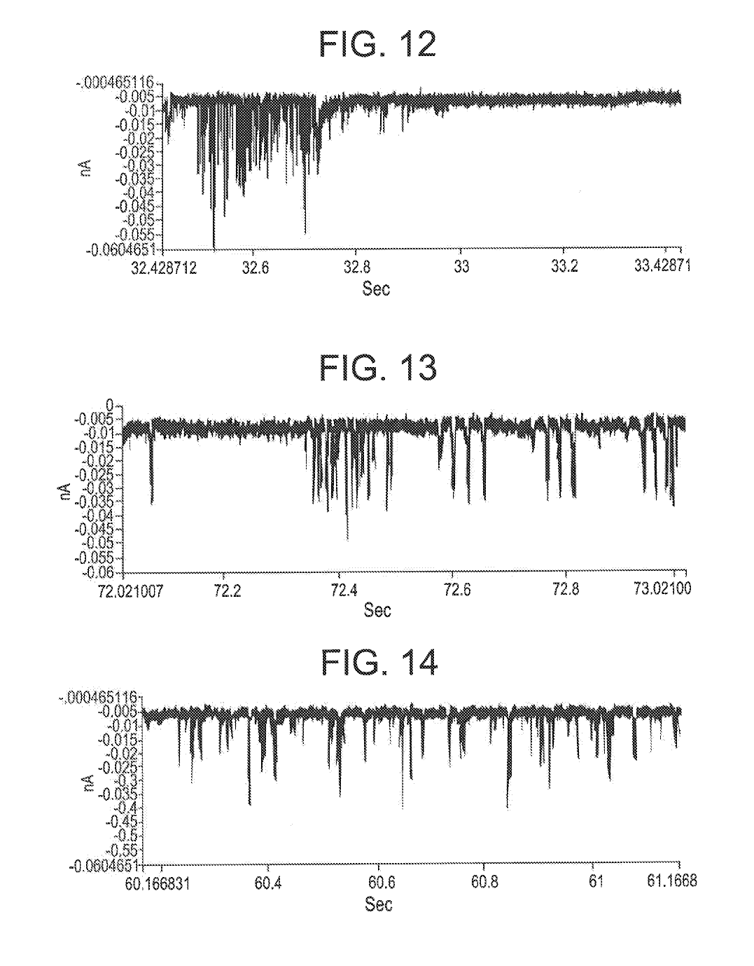

FIGS. 12-14 show the tunneling measurements with the imidazole dithiocarbamate adaptor molecule. The tunneling currents were measured at a set point of −0.5 v, 2 pA using a Pd probe and Pd substrate.

In some embodiments of the present disclosure, palladium electrodes may catalyze a number of chemical reactions. For example, and in particular, in some embodiments, cyclic voltammetry shows that phosphate is strongly adsorbed on the electrodes. Such an effect, in some embodiments, becomes more pronounced upon the potential of the palladium exceeding, for example, about +0.5V (adsorption). In addition, in some embodiments, such an effect becomes less pronounced (i.e., more negative) than about −0.5V (desorption) with respect to an Ag/AgCl reference electrode. Thus, in some embodiments, it may be advantageous to retain the palladium electrodes within such a range of potentials with respect to a reference electrode (for example). In some embodiments, the most negative electrode of the pair may be held more positive than about −0.5V vs. Ag/AgCl and the most positive of the pair, in some embodiments, may be held more negative than about +0.5V vs. Ag/AgCl.

Various implementations of the embodiments disclosed above, in particular at least some of the methods/processes disclosed, may be realized in digital electronic circuitry, integrated circuitry, specially designed ASICs (application specific integrated circuits), computer hardware, firmware, software, and/or combinations thereof. These various implementations may include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

Such computer programs (also known as programs, software, software applications or code) include machine instructions for a programmable processor, for example, and may be implemented in a high-level procedural and/or object-oriented programming language, and/or in assembly/machine language. As used herein, the term “machine-readable medium” refers to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

To provide for interaction with a user, some of the subject matter described herein may be implemented on a computer having a display device (e.g., a CRT (cathode ray tube) or LCD (liquid crystal display) monitor and the like) for displaying information to the user and a keyboard and/or a pointing device (e.g., a mouse or a trackball) by which the user may provide input to the computer. For example, this program can be stored, executed and operated by the dispensing unit, remote control, PC, laptop, smart-phone, media player or personal data assistant (“PDA”). Other kinds of devices may be used to provide for interaction with a user as well; for example, feedback provided to the user may be any form of sensory feedback (e.g., visual feedback, auditory feedback, or tactile feedback); and input from the user may be received in any form, including acoustic, speech, or tactile input.

Certain embodiments of the subject matter described herein may be implemented in a computing system and/or devices that includes a back-end component (e.g., as a data server), or that includes a middleware component (e.g., an application server), or that includes a front-end component (e.g., a client computer having a graphical user interface or a Web browser through which a user may interact with an implementation of the subject matter described herein), or any combination of such back-end, middleware, or front-end components. The components of the system may be interconnected by any form or medium of digital data communication (e.g., a communication network). Examples of communication networks include a local area network (“LAN”), a wide area network (“WAN”), and the Internet.

The computing system according to some such embodiments described above may include clients and servers. A client and server are generally remote from each other and typically interact through a communication network. The relationship of client and server arises by virtue of computer programs running on the respective computers and having a client-server relationship to each other.

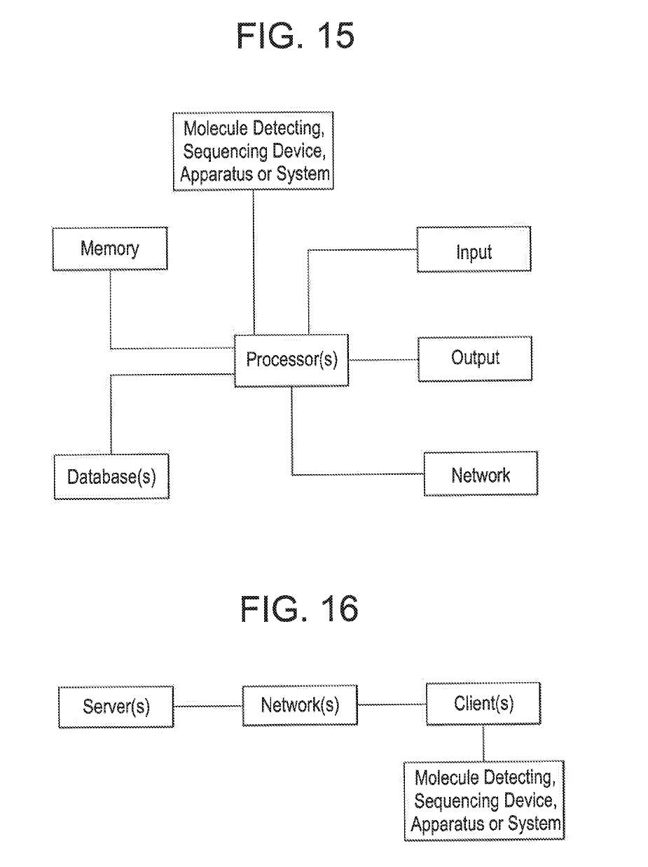

For example, as shown in FIG. 15 at least one processor which may include instructions operating thereon for carrying out one and/or another disclosed method, which may communicate with one or more databases and/or memory—of which, may store data required for different embodiments of the disclosure. As noted, the processor may include computer instructions operating thereon for accomplishing any and all of the methods and processes disclosed in the present disclosure. Input/output means may also be included, and can be any such input/output means known in the art (e.g., display, printer, keyboard, microphone, speaker, transceiver, and the like). Moreover, in some embodiments, the processor and at least the database can be contained in a personal computer or client computer which may operate and/or collect data. The processor also may communicate with other computers via a network (e.g., intranet, internet).

Similarly, FIG. 16 illustrates a system according to some embodiments which may be established as a server-client based system, in which the client computers are in communication with databases, and the like. The client computers may communicate with the server via a network (e.g., intranet, internet, VPN).

Any and all references to publications or other documents, including but not limited to, patents, patent applications, articles, webpages, books, etc., presented in the present application, are herein incorporated by reference in their entirety.

Although a few variations have been described in detail above, other modifications are possible. For example, any logic flow depicted in the accompanying figures and described herein does not require the particular order shown, or sequential order, to achieve desirable results. Other implementations may be within the scope of at least some of the following claims.

Example embodiments of the devices, systems and methods have been described herein. As noted elsewhere, these embodiments have been described for illustrative purposes only and are not limiting. Other embodiments are possible and are covered by the disclosure, which will be apparent from the teachings contained herein. Thus, the breadth and scope of the disclosure should not be limited by any of the above-described embodiments but should be defined only in accordance with claims supported by the present disclosure and their equivalents. Moreover, embodiments of the subject disclosure may include methods, systems and devices which may further include any and all elements from any other disclosed methods, systems, and devices, including any and all elements corresponding to methods, systems and devices for sensing chemical composition. In other words, elements from one or another disclosed embodiments may be interchangeable with elements from other disclosed embodiments. In addition, one or more features/elements of disclosed embodiments may be removed and still result in patentable subject matter (and thus, resulting in yet more embodiments of the subject disclosure).

What is claimed is:

1. A device for identifying single molecules, comprising:
a first electrode;
a second electrode separated from the first electrode by a dielectric material of about 1 to 5 nm thickness;
at least one adaptor molecule chemically tethered to the first electrode; and
at least one adaptor molecule chemically tethered to the second electrode,
wherein at least one of the first electrode and the second electrode comprises palladium metal.

2. The device of claim 1 wherein both of the first electrode and the second electrode comprise palladium metal.

3. The device of claim 1 wherein at least one of the first electrode and the second electrode comprise an alloy of palladium.

4. The device of claim 1 wherein the at least one adaptor molecule tethered to the first electrode, the at least one adaptor molecule tethered to the second electrode, or both comprise 4(5)-(2-mercaptoethyl)-1H imidazole-2-carboxamide.

5. The device of claim 1 wherein the at least one adaptor molecule tethered to the first electrode, the at least one adaptor molecule tethered to the second electrode, or both comprise 4H-1,2,4-triazole-3-carboxamide.

6. The device of claim 1 wherein the at least one adaptor molecule tethered to the first electrode, the at least one adaptor molecule tethered to the second electrode, or both comprise 2-(2-carbamoyl-1H-imidazol-4-yl)ethylcarbamodithioate.

7. The device of claim 1, in which the electrodes are held under potential control with respect to reference electrode.

8. The device of claim 7, wherein the potential of the palladium surface is maintained at between about +0.5V and about −0.5V vs. Ag/AgCl.

9. An apparatus for sensing a chemical composition, comprising:
means for causing a nucleic acid base to pass through a tunnel gap having electrically-separated electrodes, wherein at least one of the electrically-separated electrodes comprises palladium metal functionalized with an adaptor molecule; and
means for identifying a type of the nucleic acid base based on a tunneling current generated as a result of the nucleic acid base passing through the tunnel gap.

10. The apparatus of claim 9, wherein both of the electrically-separated electrodes comprise palladium metal.

11. The apparatus of claim 9, wherein at least one of the electrically-separated electrodes comprises an alloy of palladium.

12. The apparatus of claim 9, wherein the adaptor molecule comprises 4(5)-(2-mercaptoethyl)-1H imidazole-2-carboxamide.

13. The apparatus of claim 9, wherein the adaptor molecule comprises 4H-1,2,4-triazole-3-carboxamide.

14. The apparatus of claim 9, wherein the adaptor molecule comprises 2-(2-carbamoyl-1H-imidazol-4-yl)ethylcarbamodithioate.

15. A method of fabricating a device capable of sensing a chemical composition, comprising:
providing a first electrode;
providing a second electrode separated from the first electrode by a dielectric material of about 1 to 5 nm thickness;
chemically tethering at least one adaptor molecule to the first electrode; and
chemically tethering at least one adaptor molecule to the second electrode,
wherein at least one of the first electrode and the second electrode comprises palladium metal.

16. The method of claim 15, wherein chemically tethering at least one adaptor molecule to the first electrode, chemically tethering at least one adaptor molecule to the second electrode, or both, comprises chemically tethering 4(5)-(2-mercaptoethyl)-1H imidazole-2-carboxamide to the first electrode, second electrode, or both.

17. The method of claim 15, wherein chemically tethering at least one adaptor molecule to the first electrode, chemically tethering at least one adaptor molecule to the second electrode, or both, comprises chemically tethering 4H-1,2,4-triazole-3-carboxamide to the first electrode, second electrode, or both.

18. The method of claim 15, wherein chemically tethering at least one adaptor molecule to the first electrode, chemically tethering at least one adaptor molecule to the second electrode, or both, comprises chemically tethering 2-(2-carbamoyl-1H-imidazol-4-yl)ethylcarbamodithioate to the first electrode, second electrode, or both.

19. A method for sensing a chemical composition, comprising causing a nucleic acid base to pass through a tunnel gap having electrically-separated electrodes, wherein at least one of the electrically-separated electrodes comprises palladium; and identifying a type of the nucleic acid base based on the tunneling current generated as a result of the nucleic acid base passing through the tunnel gap.

20. A computer system for sensing a chemical composition, the system comprising at least one processor, wherein the processor includes computer instructions operating thereon for performing the steps of method 19.

21. A computer program for sensing a chemical composition, comprising computer instructions for performing the steps of method 19.

23. A computer readable medium containing a program, wherein the program includes computer instructions for performing the steps of claim 19.
